(19) United States
(12) Patent Application Publication
(10) Pub. No.: US 2008/0062059 A1
(43) Pub. Date: Mar. 13, 2008

(54) Antenna, method of manufacturing an antenna and apparatus for manufacturing an antenna

(76) Inventors: Angelo Freni, Firenze (IT); Paola Pirinoli, Torino (IT); Riccardo Zich, Torino (IT); Paolo De Vita, Empoli (IT)

Correspondence Address: PAUL A. FATTIBENE;FATTIBENE & FATTIBENE, 2480 POST ROAD, SOUTHPORT, CT, 06890, US

(21) Appl. No.: 11/825,201

(22) Filed: Jul. 5, 2007

(30) Foreign Application Priority Data
Jul. 7, 2006 (EP) 06 014 167.8

(51) Int. Cl. H01Q 19/12

(52) U.S. Cl. 343/840; 343/909

(57) ABSTRACT

An antenna comprising a plurality of re-radiating elements arranged in at least one plane being parallel to a fixed surface. The arrangement is adapted such that electromagnetic radiation emitted from the re-radiating elements in response to electromagnetic radiation arriving from a predetermined direction interferes constructively at a feed location. Additionally, the antenna comprises a feed provided at the feed location. In a method of manufacturing an antenna, the arrangement of the plurality of re-radiating elements may be calculated and the re-radiating elements can be provided in the at least one plane substantially parallel to the substrate. An apparatus for manufacturing an antenna may comprise a data processor adapted to calculate the arrangement of the plurality of re-radiating elements and means for forming the plurality of re-radiating elements.

### FIELD OF THE INVENTION

The present invention relates generally to antennas, and more specifically to antennas comprising a plurality of re-radiating elements, methods of manufacturing antennas comprising a plurality of re-radiating elements and apparatus for manufacturing antennas comprising a plurality of re-radiating elements.

### BACKGROUND OF THE INVENTION

At present, satellite receiver systems are widely used. In particular, systems for receiving TV signals broadcasted by satellites have become popular in recent years. Satellite receiver systems according to the state of the art comprise an antenna which is connected to receiver electronics. The receiver electronics in turn are connected to a TV.

An antenna for use in a satellite receiver system according to the state of the art will be described with reference to FIG. 1. FIG. 1 shows a schematic perspective view of an antenna 100 according to the state of the art. The antenna 100 comprises a parabolic reflector 101 which is typically mounted to a wall 102 of a building. Alternatively, the parabolic reflector 101 may be mounted to a support structure such as an antenna mast. A feed 103 which may comprise one or more horn antennas is supported by a feed arm 120 and provided in a geometric focus of the parabolic reflector 101. Cables 104 connect the feed 103 to the receiver electronics.

The parabolic reflector 101 focuses electromagnetic radiation 105, 106 arriving from a main beam direction of the antenna 100 to the feed 103 as indicated by arrows 107, 108. Thus, the antenna 100 has a high gain for electromagnetic radiation arriving from the main beam direction. For radiation arriving from directions other than the main beam direction, lower gain or no gain at all is obtained. Therefore, the antenna has to be oriented towards the satellite sending the signals to be received by the satellite receiver system.

A problem of the antenna 100 according to the state of the art is that, from an aesthetic point of view, it has a cumbersome and heavy appearance which is mainly caused by its three-dimensional, dish-like geometry. Therefore, antennas of satellite receiver systems have been criticized as having a negative influence on the architectural aesthetics of buildings on which they are installed. In some countries, for example in Italy, there are laws which forbid the installation of new antennas comprising parabolic reflectors or even demand the removal of already installed antennas.

### SUMMARY OF THE INVENTION

It is, therefore, an object of the present invention to provide an antenna which can be used in a satellite receiver system and which has a less obtrusive visual appearance than the antenna 100 according to the state of the art. Further objects of the present invention are to provide a method and an apparatus which allow a cost-effective manufacturing of such an antenna.

According to an aspect of the present invention, this problem is solved by an antenna comprising a plurality of re-radiating elements arranged in at least one plane being parallel to a fixed surface. The arrangement is adapted such that electromagnetic radiation emitted from the re-radiating elements in response to electromagnetic radiation arriving from a predetermined direction interferes constructively at a feed location. The antenna further comprises a feed provided at the feed location.

Due to the arrangement of the re-radiating elements in one or more planes, the antenna may be provided with a reflector having a planar configuration which has a more aesthetic appearance than the dish-like parabolic reflector 101 of the antenna 100 according to the state of the art and which can be integrated into the context of urban architecture in a more aesthetic manner. Moreover, the arrangement of the re-radiating elements in planes parallel to a fixed surface allows providing the re-radiating elements adjacent to or in the vicinity of the fixed surface. Thus, the antenna may be mounted in a visually unobtrusive manner.

In some embodiments of the present invention, the fixed surface comprises a part of a building. In particular, the fixed surface can comprise a part of at least one of a wall, a roof and a window of the building. Thus, the plurality of re-radiating elements is arranged in one or more planes being parallel to a part of the building which leads to a particularly unobtrusive appearance of the antenna.

The plurality of re-radiating elements can be provided under at least one of a plastering and a paint of the building. Thus, the re-radiating elements may be provided in a substantially invisible manner.

In some embodiments of the present invention, each of the plurality of re-radiating elements comprises at least one layer of an electrically conductive material formed on at least one surface of a substrate. Thus, a thin and lightweight configuration of the plurality of re-radiating elements can be obtained.

The at least one surface of the substrate can comprise the fixed surface itself. Advantageously, this allows providing the re-radiating elements with a minimal amount of required material.

In some embodiments of the present invention, at least one of the plurality of re-radiating elements has a shape comprising one of a plurality of coplanar concentric annular rings, a plurality of stacked concentric annular rings, a plurality of stacked rectangular patches, a patch having a plurality of coplanar symmetrical stubs, a Maltese cross, an annular patch comprising one or more slot systems, a plurality of stacked strip patches, a rectangular patch, a cross-shaped opening and a curl-shaped element, and a plurality of stacked patches electromagnetically coupled by slot systems. Advantageously, these shapes allow providing antennas wherein a high gain may be obtained for signals comprising signals of both polarization directions in a relatively wide range of frequencies and for signals.

At least one of the plurality of re-radiating elements may have a shape comprising a rectangular patch comprising slots extending from vertices of the patch towards a center of the patch. Advantageously, this shape may allow a reduction in the effort of manufacturing of the re-radiating elements. In some embodiments, at least one of the slots may comprise a pair of edges being parallel to a diagonal of said rectangular patch.

The antenna may further comprise at least one switching element adapted to open and/or close an electrical connection between opposite sides of at least one of the slots. Advantageously, this may allow the adaptation of a phase difference between the electromagnetic radiation emitted by the re-radiating elements and electromagnetic radiation incident on the antenna to adapt the antenna to a plurality of directions of incidence. At least one of the switching elements may comprise a micro-electro-mechanical system switch. The antenna can be part of a satellite receiver system.

According to another aspect of the present invention, a method of manufacturing an antenna comprises determining an orientation of a fixed surface. An arrangement of a plurality of re-radiating elements in at least one plane having the orientation of the surface is calculated. The arrangement is adapted such that electromagnetic radiation emitted from the re-radiating elements in response to electromagnetic radiation arriving from a predetermined direction interferes constructively at a predetermined feed location. A plurality of re-radiating elements is provided in at least one plane. The plurality of re-radiating elements is arranged based on the calculated arrangement. A feed is provided at the predetermined feed location.

The method of manufacturing an antenna according to the present invention allows providing an antenna wherein a reflector has a planar configuration which has a more aesthetic appearance than the dish-like parabolic reflector 101 of the antenna 100 according to the state of the art. Furthermore, by calculating the arrangement of the re-radiating elements in accordance with the orientation of the fixed surface and the predetermined location of the feed and providing such an arrangement of re-radiating elements and the feed, the configuration of the antenna may be individually adapted to the location where it is installed. Thus, a visually unobtrusive design of the antenna can be obtained.

The fixed surface can comprise a part of a building, in particular a part of at least one of a roof, a wall and a window of the building. Moreover, in some embodiments of the present invention, the plurality of re-radiating elements can be provided under at least one of a plastering and a paint of the building. The antenna can be provided as a component of a satellite receiver system.

In embodiments of the present invention, the calculation of the arrangement of the plurality of re-radiating elements comprises providing a model of arrangement having a plurality of free parameters. At least one antenna gain is calculated for electromagnetic radiation in a predetermined frequency range for an antenna comprising a plurality of re-radiating elements arranged according to the model of arrangement. The at least one antenna gain is optimized with respect to the plurality of free parameters. This method of calculation allows the determination of an arrangement of the re-radiating elements wherein a high gain can be obtained by the antenna for the electromagnetic radiation received.

The calculation of the antenna gain can comprise calculating a plurality of antenna gains in the predetermined frequency range, the predetermined frequency range having a bandwidth of 17% or more. The electromagnetic radiation may comprise signals of different polarization.

In some embodiments of the present invention, the model of arrangement defines for each of the plurality of re-radiating elements a shape comprising one of a plurality of coplanar concentric annular rings, a plurality of stacked concentric annular rings, a plurality of stacked rectangular patches, a patch having a plurality of coplanar symmetrical stubs, a Maltese cross, an annular patch comprising one or more slot systems, a plurality of stacked strip patches, a rectangular patch, a cross-shaped opening and a curl-shaped element, and a plurality of stacked patches electromagnetically coupled by slot systems.

The model of arrangement may define, for each of the plurality of re-radiating elements, a shape comprising a rectangular patch comprising slots extending from vertices of the patch towards a center of the patch.

Each of the slots may comprise a pair of edges being parallel to a diagonal of the rectangular patch.

In some embodiments, at least one switching element adapted to open and/or close an electrical connection between opposite sides of at least one of the slots may be provided.

The at least one switching elements may comprise a micro-electrical-mechanical system switch.

In some embodiments of the present invention, the optimization comprises performing an evolutionary optimization algorithm. Advantageously, this allows an efficient optimization, in particular for models of arrangement comprising a large number of degrees of freedom.

In embodiments of the present invention, the provision of the plurality of re-radiating elements comprises depositing an electrically conductive material on at least one surface of a substrate. The at least one surface of the substrate can comprise the fixed surface.

The deposition of the layer of the electrically conductive material can comprise forming a mask over a layer of electrically conductive material provided over the at least one surface of the substrate, removing portions of the layer of electrically conductive material which are not covered by the mask and removing the mask. Thus, the re-radiating elements can be formed with a high precision.

In other embodiments, the deposition of the electrically conductive material comprises spraying a paint comprising the electrically conductive material to the at least one surface of the substrate. Thus, the re-radiating elements can be formed in a cost-effective manner.

A stencil having a plurality of openings arranged according to the arrangement of the plurality of re-radiating elements can be provided over the at least one surface of the dielectric substrate. Thus, the paint comprising the electrically conductive material may be sprayed to the correct portions of the substrate in an efficient manner.

In further embodiments of the present invention, the deposition of the electrically conductive material comprises printing a pattern corresponding to the arrangement of the plurality of re-radiating elements on the substrate using a paint comprising the electrically conductive material. Thus, an individual arrangement of the re-radiating elements can be obtained in a both precise and cost-effective manner.

According to a further aspect of the present invention, an apparatus for manufacturing an antenna comprises a data processor configured to calculate an arrangement of a plurality of re-radiating elements in at least one plane having an orientation corresponding to an orientation of a fixed surface. The arrangement is adapted such that electromagnetic radiation emitted from the re-radiating elements in response to electromagnetic radiation arriving from a predetermined direction interferes constructively at a predetermined feed location. The apparatus further comprises means for forming a plurality of re-radiating elements on at least one surface of a substrate. The plurality of re-radiating elements is arranged based on the predetermined arrangement.

The apparatus according to the present invention allows forming an antenna which may be integrated in an architectural context in an aesthetic manner and which may be mounted in the vicinity of a building in a visually unobtrusive manner. The configuration of the data processor allows adapting the antenna to the location where it is to be mounted, in particular to the orientation of the fixed surface and the feed location.

In embodiments of the present invention, the data processor is configured to provide a model of arrangement having a plurality of free parameters, to calculate at least one antenna gain for electromagnetic radiation in a predetermined frequency range for an antenna comprising a plurality of re-radiating elements arranged according to the model of arrangement and to optimize the at least one antenna gain with respect to the plurality of free parameters.

In some embodiments, the at least one antenna gain comprises a plurality of antenna gains for a plurality of frequencies in the predetermined frequency range, the predetermined frequency range having a bandwidth of at least 17%, the electromagnetic radiation comprising signals with different polarizations.

The model of arrangement can define for each of the plurality of re-radiating elements a shape comprising one of a plurality of coplanar concentric annular rings, a plurality of stacked concentric annular rings, a plurality of stacked rectangular patches, a patch having a plurality of coplanar symmetrical stubs, a Maltese cross, an annular patch comprising one or more slot systems, a plurality of stacked strip patches, a rectangular patch, a cross-shaped opening and a curl-shaped element, and a plurality of stacked patches electromagnetically coupled by slot systems.

In some embodiments, the model of arrangement may define, for each of the plurality of re-radiating elements, a shape comprising a rectangular patch comprising slots extending from vertices of the patch towards the center of the patch.

Each of the slots may comprise a pair of edges being parallel to a diagonal of the rectangular patch.

The apparatus may further comprise means for providing at least one switching element adapted to open or close an electrical connection between opposite sides of at least one of the slots.

The at least one switching element may comprise a micro-electrical-mechanical system switch.

The data processor can be adapted to perform an evolutionary optimization.

In embodiments of the present invention, the means for forming a plurality of re-radiating elements comprise means for forming a mask over a layer of electrically conductive material deposited over the at least one surface of the substrate and means for removing portions of the layer of electrically conductive material which are not covered by the mask and means for removing the mask.

In other embodiments, the means for forming a plurality of re-radiating elements on at least one surface of the substrate comprise means for forming a stencil having a plurality of openings arranged according to the arrangement of the plurality of re-radiating elements over the at least one surface of the substrate.

In further embodiments, the means for forming a plurality of re-radiating elements on at least one surface of a substrate comprise a printer adapted to print a pattern corresponding to the arrangement of the plurality of re-radiating elements on the at least one surface of the substrate using a paint comprising an electrically conductive material.

### BRIEF DESCRIPTION OF THE DRAWINGS

Embodiments of the present invention will now be described with reference to the accompanying drawings, wherein

FIG. 1 shows a schematic perspective view of an antenna according to the state of the art;

FIG. 2b shows a schematic perspective view of an antenna according to the present invention;

FIG. 3 shows a schematic cross-sectional view of an antenna according to the present invention;

FIGS. 4a and 4b show schematic views of antennas according to the present invention being mounted on a roof and a wall of a house, respectively;

FIGS. 5a to 5j show schematic views of re-radiating elements which may be used in antennas according to the present invention;

FIGS. 5k and 5l show schematic views of a current distribution in the re-radiating element shown in FIG. 5j;

FIGS. 6a to 6c show plots of a dependency of the gain of an antenna according to the present invention on the direction of arrival of electromagnetic radiation of various frequencies;

FIGS. 7a and 7b show schematic cross-sectional views of an antenna according to the present invention in stages of a manufacturing process according to the present invention;

FIG. 8 shows a schematic cross-sectional view of an antenna according to the present invention in stages of a manufacturing process according to another embodiment of the present invention;

FIG. 9 shows a schematic cross-sectional view of an antenna according to the present invention in stages of a manufacturing process according to yet another embodiment of the present invention; and

FIG. 10 shows a schematic perspective view of an apparatus for manufacturing an antenna according to an embodiment of the present invention.

### DETAILED DESCRIPTION OF THE PREFERRED EMBODIMENTS

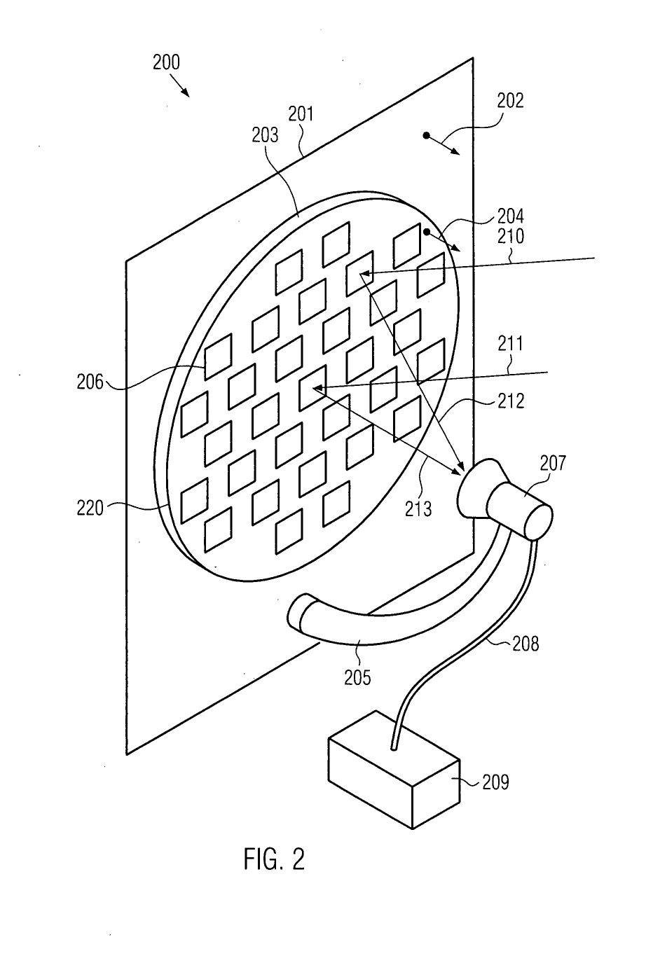

FIG. 2 shows a schematic perspective view of an antenna 200 according to the present invention.

The antenna 200 comprises a substrate 203 having a surface 220. The substrate 203 is mounted on a fixed surface 201. A normal direction 204 of the surface 220 of the substrate 203 is substantially parallel to a normal direction 202 of the fixed surface 201. Thus, the fixed surface 201 and the surface 220 of the substrate are substantially parallel to each other.

The fixed surface 201 can comprise a part of a building. In particular, the fixed surface can comprise a part of a roof, a wall and/or a window of the building.

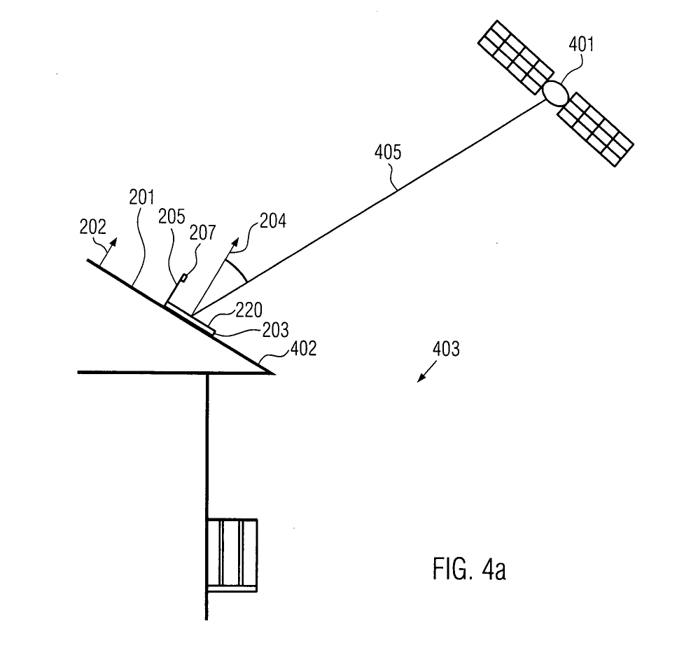

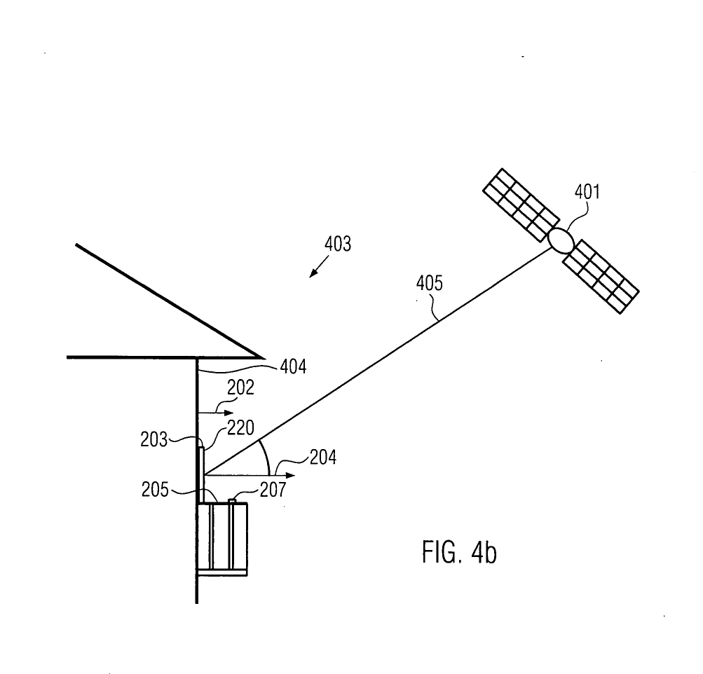

FIG. 4a shows a schematic side view of an embodiment of the present invention wherein the antenna 200 is mounted on a roof 402 of a house 403. In this embodiment, the fixed surface 201 is provided in form of a surface of the roof 402. The normal direction 204 of the surface 220 of the substrate 203 can be substantially parallel to the normal direction 202 of the roof surface. A satellite 401 can send electromagnetic radiation 405 comprising signals to be transmitted. The electromagnetic radiation impinges relative to the surface 220 of the substrate 203 from a direction of arrival which is determined by the normal direction of the surface of the roof 402 and the position of the satellite 401.

FIG. 4b shows a schematic side view of another embodiment of the present invention wherein the antenna 200 is mounted on a wall 404 of the house 403. In this embodiment, the fixed surface 201 is provided by the surface of the wall 404. The normal direction 204 of the surface 220 of the substrate 203 can be substantially parallel to the normal direction 202 of the surface of the wall 404. Thus, the surface 220 of the substrate 203 and the wall surface are substantially parallel to each other. Electromagnetic radiation 405 sent by the satellite 401 impinges relative to the surface 220 of the substrate 203 from a direction of arrival which is determined by the normal direction 202 of the surface of the wall 404 and the position of the satellite 401.

The substrate 203 can comprise a plate of a dielectric material, for example a plate of glass or a plate of plastics. In other embodiments of the present invention, the substrate 203 can comprise a ceramic material such as aluminium oxide or an epoxy. In further embodiments, the substrate 203 can comprise a printed circuit board substrate.

The surface 220 of the substrate 203 need not be distinct from the fixed surface 201. In some embodiments of the present invention, the substrate 203 can be provided in form of a stationary support member comprising the fixed surface 201. In such embodiments, the surface 220 of the substrate 203 is identical to the fixed surface 201. In one particular embodiment of the present invention, the substrate 203 is provided in form of a window pane which is installed in the window of a building. In other embodiments of the present invention, the substrate 203 can be provided in the form of a wall and/or a roof of a building. In such embodiment, the wall surface or roof surface, respectively, may be planarized by means of methods known to persons skilled in the art such as grinding and/or polishing when the antenna 200 is installed.

As illustrated in FIG. 2, a plurality of re-radiating elements 206 are formed on the surface 220 of the substrate 203.

Each of the plurality of re-radiating elements 206 can comprise a layer of an electrically conductive material formed on the surface 220 of the substrate 203. A shape of each of the plurality of re-radiating elements 206 is adapted such that electromagnetic radiation 210, 211 having a frequency in a frequency range of interest and arriving from a predetermined direction excites electrical oscillations in the layer of electrically conductive material. Due to the electrical oscillations, the re-radiating elements emit a secondary electromagnetic radiation 212, 213 having the same frequency as and a fixed phase relation to the exciting electromagnetic radiation.

The layer of electrically conductive material may comprise a metal, for example copper or aluminum. In other embodiments, the layer of electrically conductive material may comprise a transparent conductive material, for example indium tin oxide. Re-radiating elements comprising a transparent conductive material are particularly advantageous in embodiments of the present invention wherein the fixed surface 201 comprises a surface of a window of a building.

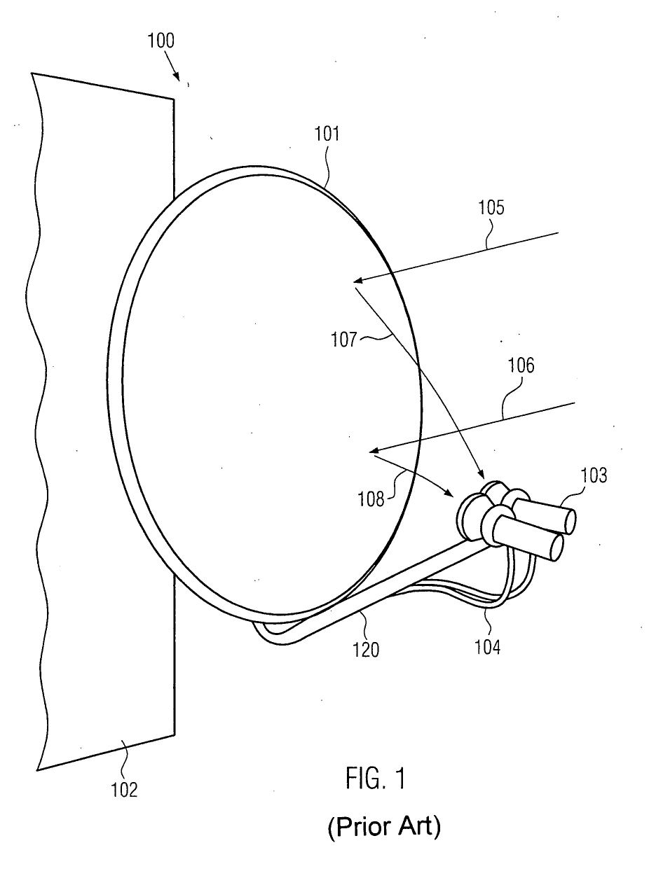

The antenna 200 further comprises a feed 207. A feed support 205 which can be mounted to the fixed surface 201 and/or the substrate 203 fixes the feed 207 at a predetermined feed location. Similar to the feed 103 in the antenna 100 according to the state of the art described above with reference to FIG. 1, the feed 207 can comprise one or more horn antennas or any other type of feed known to persons skilled in the art. A cable 208 which, in some embodiments of the present invention, can be a coaxial cable connecting the feed 207 to a receiver 209 of a type known to persons skilled in the art, for example a receiver of a satellite receiver system.

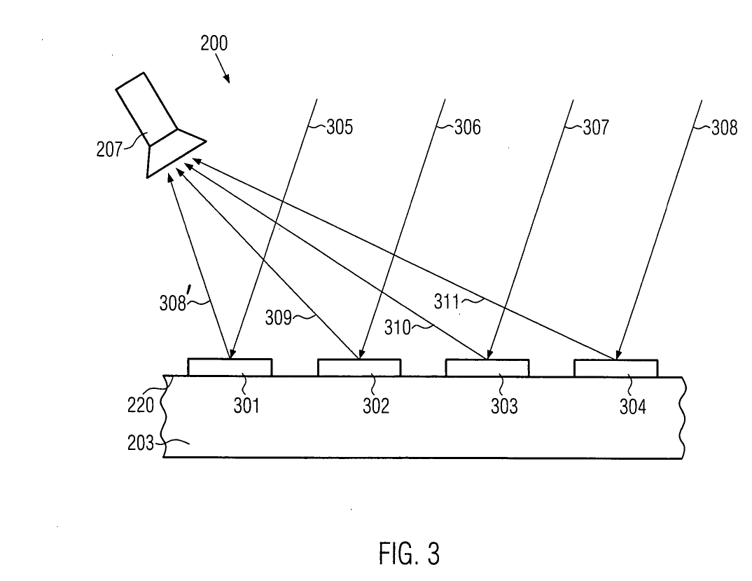

FIG. 3 shows a schematic cross-sectional view of a portion of the antenna 200. Reference numerals 301, 302, 303 and 304 indicate individual re-radiating elements arranged on the surface of the substrate 203. Arrows 305, 306, 307 and 308 indicate electromagnetic radiation arriving from a predetermined direction and impinging on the re-radiating elements 301, 302, 303, 304. In embodiments of the present invention wherein the antenna 200 is provided as a component of a satellite receiver system, the predetermined direction may be a direction from which signals sent from a broadcasting satellite arrive. As persons skilled in the art know, broadcasting satellites are usually provided in a geostationary orbit such that the signals sent by the satellite always arrive from the same direction.

The re-radiating element 301 emits secondary electromagnetic radiation 308′ in response to the electromagnetic radiation 305. The secondary electromagnetic radiation 308′ has the same frequency as the electromagnetic radiation 305 and a fixed phase relation to the electromagnetic radiation 305. A phase difference between the electromagnetic radiation 305 and the secondary electromagnetic radiation 308′ depends on the configuration of the re-radiating element 301. In particular, the phase difference may be influenced by the shape of the re-radiating element 301 and/or thickness and/or conductivity of the layer of electrically conductive material from which the re-radiating element 301 is formed. Therefore, the phase difference between the electromagnetic radiation 305 and the secondary electromagnetic radiation 308′ may be varied by adapting one of these properties. In particular, the phase difference can be varied by adapting the shape of the re-radiating element 301. At least a portion of the secondary radiation 308′ is emitted in a direction towards the feed 207.

Similar to the re-radiating element 301, the re-radiating elements 302, 303, 304 emit secondary radiation 309, 310, 311. A phase relation between the secondary radiation 309 emitted by the re-radiating element 302 can be varied by adapting the configuration of the re-radiating element 302. Similarly, a phase relation between the secondary radiation 310 emitted by the re-radiating element 303 and the electromagnetic radiation 307 and a phase relation between the secondary radiation 311 emitted by the re-radiating element 304 and the electromagnetic radiation 308 can be varied by adapting the configuration of the re-radiating elements 303, 304.

An arrangement of the re-radiating elements 301, 302, 303, 304 is adapted such that the secondary electromagnetic radiation 308′, 309, 310, 311 emitted by the re-radiating elements 301, 302, 303, 304 in response to the electromagnetic radiation 305, 306, 307, 308 interferes constructively at the location of the feed 207. The term “arrangement of re-radiating elements” shall denote both the position of the plurality of re-radiating elements and the configuration of individual re-radiating elements. In order to insure constructive interference, the phase relation between the electromagnetic radiation 305, 306, 307, 308 and the secondary electromagnetic radiation 308′, 309, 310, 311 may be controlled by varying the configuration of the re-radiating elements 301, 302, 303, 304 in such a manner that the secondary electromagnetic radiation 308′, 309, 310, 311 emitted by the individual re-radiating elements 301, 302, 303, 304 is in phase at the feed location.

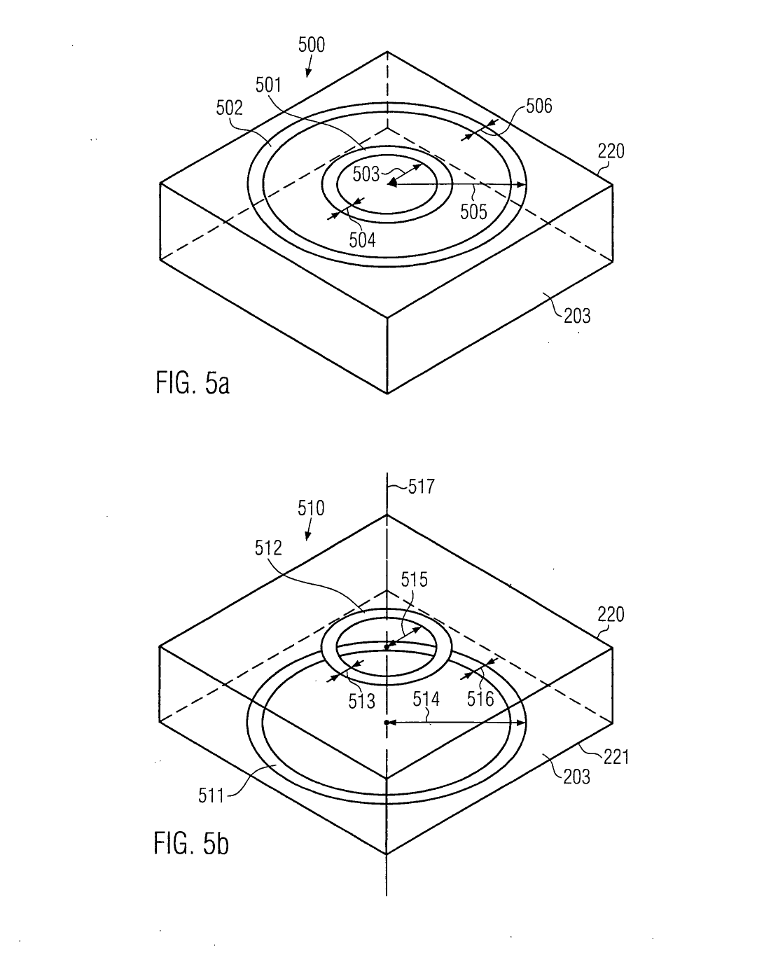

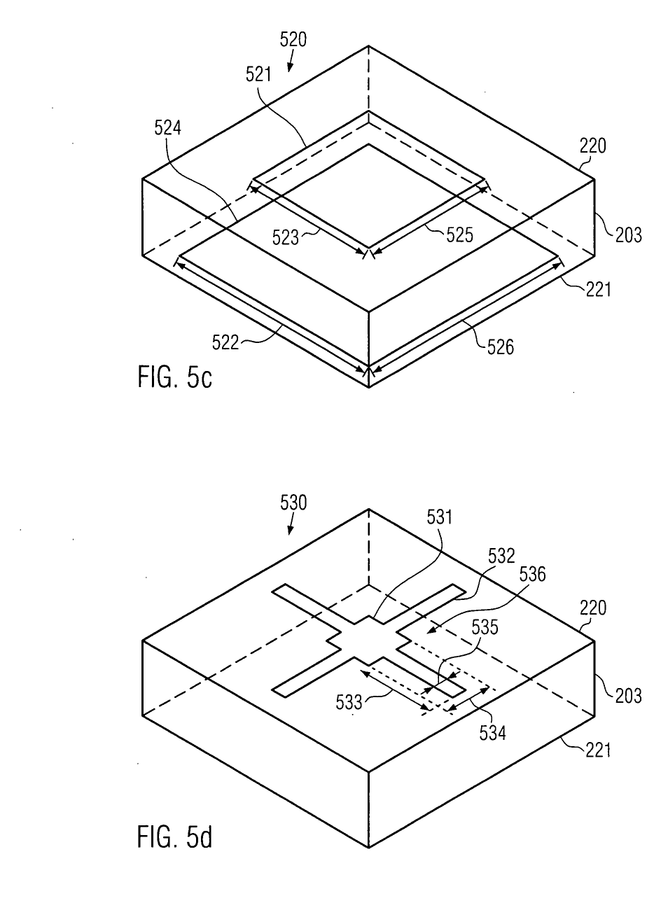

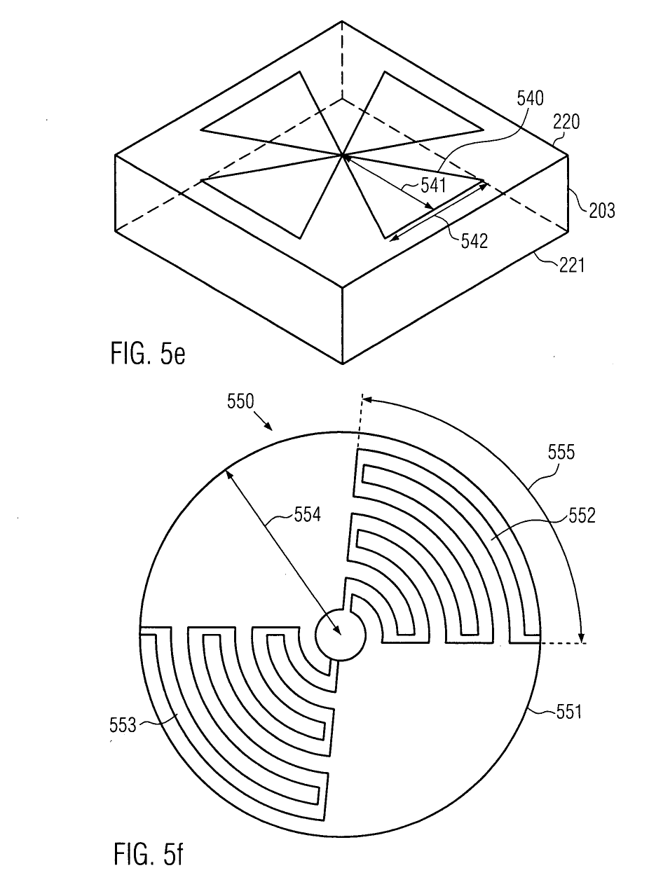

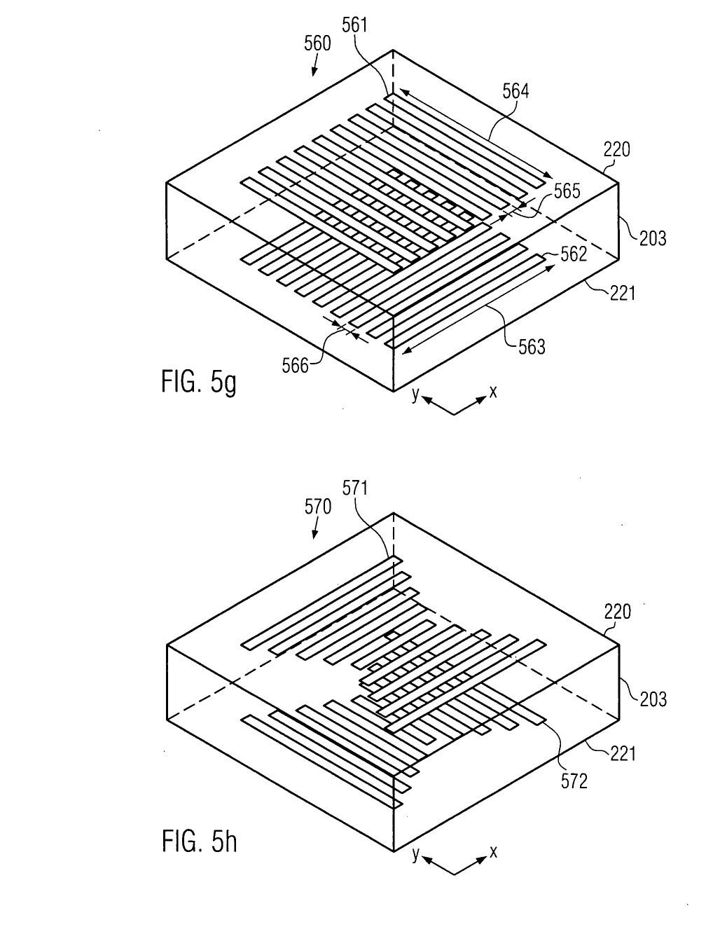

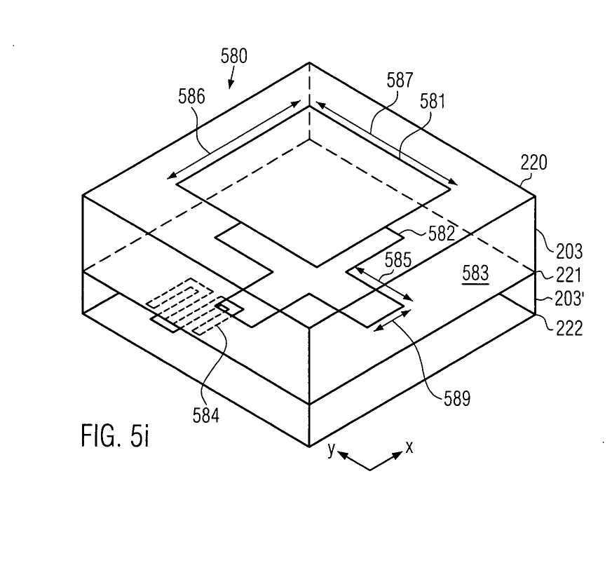

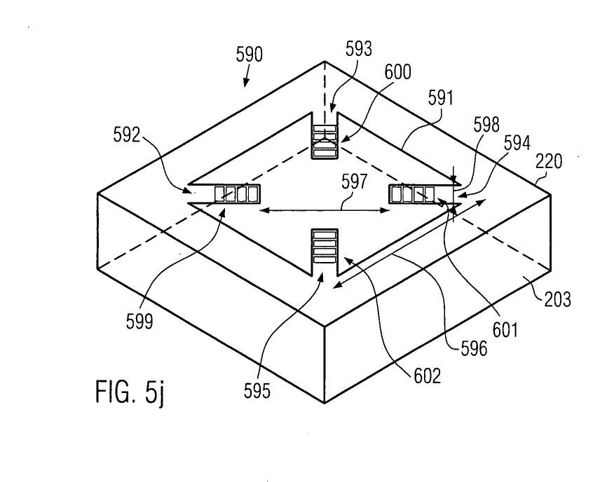

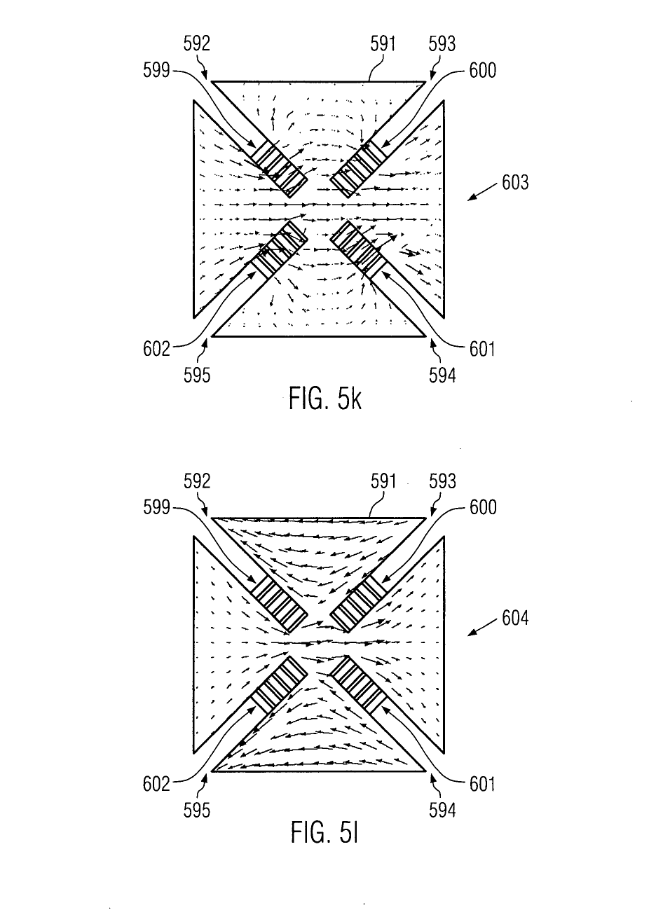

FIG. 5a shows a schematic perspective view of a re-radiating element 500 which may be provided in the antenna 200 according to the present invention. The re-radiating element 500 comprises a first annular ring 501 and a second annular ring 502 which are concentric and are formed on the surface 220 of the substrate 203. The shape of the re-radiating element 500 can be characterized by a radius 503 of the first annular ring 501, a radius 505 of the second annular ring 502, a width 504 of the first annular ring 501 and a width 506 of the second annular ring 502. Some or all of these parameters may be varied in order to control the phase relation between electromagnetic radiation impinging on the re-radiating element 500 and electromagnetic radiation emitted by the re-radiating element 500.

Re-radiating elements in antennas according to the present invention need not be formed on a single surface of the substrate 203. In other embodiments, components of re-radiating elements may be formed on different surfaces of the substrate 203. FIG. 5b shows a schematic perspective view of a re-radiating element 510 which may be provided in the antenna 200 in such an embodiment.

The re-radiating element 510 comprises a first annular ring 512 which is formed on a first surface 220 of the substrate 203 and a second annular ring 511 which is formed on a second surface 221 of the substrate 203. Since the first annular ring 512 and the second annular ring 511 are formed on different surfaces of the substrate 203, they are arranged in a stacked relationship. A center of the first annular ring 512 and a center of the second annular ring 511 are substantially located on a line 517 which is perpendicular to the first surface 220 and the second surface 221 of the substrate 203. Thus, the first annular ring 512 and the second annular ring 511 are concentric.

Parameters which may be varied in order to control the phase relation between electromagnetic radiation impinging on the re-radiating element 510 and electromagnetic radiation emitted by the re-radiating element 510 include a radius 515 of the first annular ring 512, a radius 514 of the second annular ring 511, a width 513 of the first annular ring and a width 516 of the second annular ring 511.

FIG. 5c shows a schematic perspective view of a re-radiating element 520 which may be used in further embodiments of the antenna 200 according to the present invention. The re-radiating element 520 comprises a first rectangular patch 521 and a second rectangular patch 524 which are provided in a stacked relationship wherein the first rectangular patch 521 if formed on a first surface 220 of the substrate 203 and the second rectangular patch 524 is formed on a second surface 221 of the substrate 203.

Parameters which may be varied in order to control the phase relation between electromagnetic radiation impinging on the re-radiating element 520 and electromagnetic radiation emitted by the re-radiating element 520 include a length 523 and a width 525 of the first rectangular patch 521 and a length 522 and a width 526 of the second rectangular patch 524.

FIG. 5d shows a schematic perspective view of a re-radiating element 530 which may be provided in other embodiments of the antenna 200 according to the present invention. The re-radiating element 530 comprises a patch 536. The patch 536 comprises a quadratic center portion 531 and a plurality of coplanar symmetrical rectangular stubs 532 which are provided adjacent the edges of the center portion 531 and are in electrical contact thereto. The patch 536 is provided on the surface 220 of the substrate 203.

Parameters which may be varied in order to control the phase relation between electromagnetic radiation impinging on the re-radiating element 530 and electromagnetic radiation emitted by the re-radiating element 530 include a side length 534 of the center portion 531, a width 535 of the stubs 532 and a length 533 of the stubs 532.

FIG. 5e shows a schematic perspective view of a re-radiating element 540 which may be provided in still further embodiments of the antenna 200 according to the present invention. The re-radiating element 540 has the shape of a Maltese cross and is formed on the surface 220 of the substrate 203. Parameters which may be varied in order to control the phase relation between electromagnetic radiation impinging on the re-radiating element 540 and electromagnetic radiation emitted by the re-radiating element 540 include an arm length 541 and an arm width 542.

FIG. 5f shows a top view of a re-radiating element 550 which may be provided in still further embodiments of the antenna 200 according to the present invention. The re-radiating element 550 comprises an annular patch 551. The annular patch 551 comprises slot systems 552, 553 provided in sectors of the annular patch 551. Parameters which may be varied in order to control the phase relation between electromagnetic radiation impinging on the re-radiating element 550 and electromagnetic radiation emitted by the re-radiating element 550 include a radius 554 of the patch 551 and an angle 555 of the sectors wherein the slot systems 552, 553 are formed.

FIG. 5g shows a schematic perspective view of a re-radiating element 560 which may be provided in other embodiments of the antenna 200 according to the present invention. The re-radiating element 560 comprises a first plurality of strip patches 561 and a second plurality of strip patches 562. The first plurality of strip patches 561 is arranged on the first surface 220 of the substrate 203 and the second plurality of strip patches 562 is arranged on the second surface 221 of the substrate 203. Thus, the first plurality of strip patches 561 and the second plurality of strip patches 562 are provided in a stacked arrangement. A longitudinal direction of the first plurality of strip patches 561 is arranged parallel to a first direction y and a longitudinal direction of the second plurality of strip patches 562 is arranged parallel to a second direction x which is substantially orthogonal to the first direction y.

Parameters which may be varied in order to control the phase relation between electromagnetic radiation impinging on the re-radiating element 560 and electromagnetic radiation emitted by the re-radiating element 560 include a length 564 of the first plurality of strip patches 561, a width 565 of the first plurality of strip patches 561, a length 563 of the second plurality of strip patches 562 and a width 566 of the second plurality of strip patches 562. Furthermore, the spacing between the strips may be varied.

The number of strip patches in the first plurality of strip patches 561 and the second plurality of strip patches 562 need not be nine, as shown in FIG. 5h. In other embodiments, another even or odd number of strip patches, for example seven strip patches, may be provided in each of the first plurality of strip patches 561 and the second plurality of strip patches 562.

In embodiments of the present invention wherein re-radiating elements comprise stacked pluralities of strip patches, the dimensions of the individual strips need not be equal as shown in FIG. 5g. In other embodiments, a re-radiating element may comprise one or more pluralities of stacked strip patches comprising strips having different length.

FIG. 5h shows a schematic perspective view of a re-radiating element 570 according to one such embodiment of the present invention. The re-radiating element 570 comprises a first plurality of strip patches 571 and a second plurality of strip patches 572 which are provided in a stacked arrangement wherein the first plurality of strip patches 571 is formed on the first surface 220 of the substrate 203 and the second plurality of strip patches 571 is formed on the second surface 221 of the substrate 203. The individual strips of the pluralities of strip patches 571, 572 have different lengths. In some embodiments of the present invention, the individual strips may also have different widths. Length and width of the individual strips may be varied in order to control the phase relation between electromagnetic radiation impinging on the re-radiating element 570 and electromagnetic radiation emitted by the re-radiating element 570.

FIG. 5i shows a schematic perspective view of a re-radiating element 580 which may be provided in further embodiments of the present invention. On the first surface 220 of the substrate 203, a rectangular patch 581 comprising a layer of an electrically conductive material is formed. On the second surface 221 of the substrate 203, a layer 583 of an electrically conductive material is formed. The layer 583 of electrically conductive material comprises a cross-shaped opening 582 located opposite to the rectangular patch 581. A second substrate 203′ is attached to the second surface 221 of the substrate 203. On a surface 222 of the second substrate 203′ which is opposite to the second surface 221 of the substrate 203, a curl-shaped element 584 is formed. The curl-shaped element 584 may comprise a layer of an electrically conductive material formed on the surface 222 of the second substrate 203′ and can be located at least partially under the opening 582.

Parameters which may be varied in order to control the phase relation between electromagnetic radiation impinging on the re-radiating element 580 and electromagnetic radiation emitted by the re-radiating element 580 include length 586 and width 587 of the rectangular patch 581 as well as length 585 and width 589 of the bars of the cross-shaped opening 582. Additionally, the phase relation may be controlled by varying the position of the curl-shaped element 584. The curl-shaped element 584 may be moved in a first direction y and a second direction x which can be perpendicular to each other. Varying the position of the curl-shaped element 584 provides a possibility to fine-tune the phase relation between the radiation impinging on the re-radiating element 580 and the radiation reflected from the re-radiating element 580. Thus, advantageously a greater accuracy of the control of the phase relation may be obtained.

FIG. 5j shows a schematic perspective view of a re-radiating element 590 which may be provided in still further embodiments of the present invention. The re-radiating element comprises a patch 591 substantially having the shape of a rectangle comprising slots 592, 593, 594, 595 starting from vertices of the patch 591 and being directed towards a center of the patch 591.

In some embodiments, the patch 591 may have a substantially square configuration and the slots 592, 593, 595, 595 may have substantially identical dimensions. In such embodiments, the patch 591 may have a substantially square symmetry. The symmetry of the patch 591 may help to obtain substantially identical phase differences between electromagnetic radiation which is incident on the re-radiating element 590 and electromagnetic radiation emitted by the re-radiating element for different polarization directions of the incident electromagnetic radiation. Hence, the antenna 200 when comprising the re-radiating element 590 can be adapted to receive electromagnetic radiation comprising two directions of polarization.

In embodiments wherein the patch 591 has a substantially square symmetry, parameters which may be varied in order to control the phase relation between electromagnetic radiation impinging on the re-radiating element and electromagnetic radiation emitted by the re-radiating element 520 may include a side length 596 of the patch 591, a depth of the slots 592, 593, 594, 595 or, equivalently, a distance 597 between diagonally opposed pairs of the slots 592, 593, 594, 595, as well as a width 598 of the slots 592, 593, 594, 595. In some of these embodiments, the width 598 of the slots 592, 593, 594, 595 may be set to a fixed value, and only the side length 596 and the distance 597 are varied to control the phase relation. Advantageously, this may help to reduce the number of free parameters.

The re-radiating element 590 may have electrical characteristics similar to those of the re-radiating element 540 having the shape of a Maltese cross described above with reference to FIG. 5e. In particular, variations of the side length 596 and the distance 597 may provide variations of the phase of the electromagnetic radiation emitted by the re-radiating element 590 in response to incident electromagnetic radiation similar to those obtained by varying the arm length 541 and the arm width 542 in the re-radiating element 540.

Compared to the re-radiating element 540 described above with reference to FIG. 5e, the re-radiating element 590 may be easier to manufacture, since the central zone of the Maltese cross shape of the re-radiating element 540 may, depending on the arm width 542, be relatively small. Hence, relatively low manufacturing tolerances may be required. Contrary thereto, the central zone of the re-radiating element 590 may have a moderate size for a variety of values of the side length 596 and the distance 597. Hence, in the manufacturing of the re-radiating element 590, less precise techniques may be used.

In some embodiments of the present invention, one or more switching elements 599 may be provided in the slot 592. Similarly, in the slots 593, 594, 595, one or more switching elements 600, 601 and 602, respectively, may be provided. Each of the switching elements 599, 600, 601, 602 may be electrically connected to portions of the patch 591 on both sides of the slot wherein the respective switching element is provided. Each of the switching elements 599, 600, 601, 602 may comprise a closed state wherein the switching element provides an electrical connection between the sides of the slot and an open state wherein substantially no electrical connection is provided.

The phase difference between electromagnetic radiation incident on the re-radiating element 590 and the electromagnetic radiation emitted by the re-radiating element 590 in response to the incident electromagnetic radiation may be controlled by opening or closing some or all of the switching elements 599, 600, 601, 602.

In FIG. 5k, arrows 603 schematically illustrate a current distribution in the patch 590 in a state wherein the switching elements 599, 600, 601, 602 are closed. A current distribution in the patch 590 in a state wherein the switching elements 599, 600, 601, 602 are open is illustrated by arrows 604 in FIG. 5l. As can be seen by a comparison of FIGS. 5k and 5l, the current distribution in the patch 590 and, hence, the phase of the radiation emitted by the patch 590, can be controlled by opening or closing the switching elements 599, 600, 601, 602.

The current distribution represented by arrows 603 which is obtained if the switching elements 599, 600, 601, 602 are open may correspond to a current distribution obtained in a patch having substantially identical dimensions 596, 597, 598 and wherein no switching elements 599, 600, 601, 602 are provided. The current distribution which is obtained if the switching elements 599, 600, 601, 602 are closed may correspond to the current distribution obtained in a patch having a substantially identical side length 596 and a substantially identical width 598 of the slots 592, 593, 594, 595 but a different distance 597 between diagonally opposed slots. More specifically, the current distribution, and, hence, also the phase of the radiation emitted by the patch 590, may correspond to the current distribution and the phase, respectively, obtained in a patch having shorter slots wherein the distance between the shorter slots corresponds to the distance between closed switching elements 599, 600, 601, 602 which are respectively provided in diagonally opposite ones of the slots 592, 593, 594, 595.

In some embodiments, a plurality of switching elements may be provided in each of the slots 592, 593, 594, 595. The switching elements may be provided at different positions within the slots 592, 593, 594, 595. In some of these embodiments, as shown in FIGS. 5j, 5k, 5l, a plurality of switching elements, for example four switching elements, may be arranged in a row in each of the slots 592, 593, 594, 595. The switching elements may have different distances from the inner ends of the slots such that three or more different current distributions and, hence, phases of the radiation emitted by the re-radiating element 590 can be obtained.

The modification of the phases of the radiation emitted by the re-radiating element 590 may be used to vary the direction of arrival for which incident electromagnetic radiation interferes constructively at the location of the feed 207. Thus, a scan of an angle of the antenna 200 can be performed.

In some embodiments of the present invention, each of the switching elements 599, 600, 601, 602 may comprise a Micro-Electro-Mechanical System (MEMS) switch. As persons skilled in the art know, a MEMS switch may comprise a mobile element which may be moved by means of one or more actuators provided in the MEMS switch. The actuators may be operated electrically. For this purpose, electrically conductive lines (not shown) may connect the actuators and a control unit which may, in some embodiments, comprise a computer. By moving the mobile element, the MEMS switch can be switched between the open and the closed configuration. The components of the MEMS switch can be fabricated from a common silicon substrate using microfabrication techniques such as photolithography, etching, deposition and/or oxidation. Advantageously, MEMS switches may have a relatively small size.

The present invention is not restricted to embodiments wherein the switching elements 599, 600, 601, 602 comprise MEMS switches. In other embodiments, each of the switching elements 599, 600, 601, 602 may comprise at least one of a field effect transistor, a bipolar transistor, a relay, and a pair of jumper pins provided on opposite sides of one of the slots 592, 593, 594, 595 into which a jumper may be inserted to provide an electrical connection between the sides of the one of the slots 592, 593, 594, 595.

In other embodiments of the present invention, each of the plurality of re-radiating elements 206 can comprise a plurality of stacked patches electromagnetically coupled by slot systems.

The plurality of re-radiating elements 206 in the antenna 200 according to the present invention may be arranged in a periodic pattern. For example, the plurality of re-radiating elements 206 can be arranged in a lattice configuration, for example a square lattice or a triangular lattice. In other embodiments, the plurality of re-radiating elements 206 can be arranged in a non-periodic pattern. For example, the re-radiating elements 206 can be provided at randomly chosen locations or may be arranged in a quasiperiodic pattern.

The arrangement of the plurality of re-radiating elements 206 in the antenna 200 may individually be adapted to the location where the antenna 200 is installed. In the following, a method of manufacturing an antenna according to an embodiment of the present invention allowing such an individual adaptation of the arrangement of the plurality of re-radiating elements 206 will be described.

The orientation of the fixed surface 201 is determined. To this end, measurements may be performed in order to determine the normal direction 202 of the fixed surface 201. This can be done by means of methods known to persons skilled in the art, for example by means of measurements performed with well-known instruments such as a theodolite. Then, the location of the feed 207 is determined. This can be done by providing the feed support 205 at an appropriate location.

An arrangement of the plurality of re-radiating elements is established, wherein the arrangement is adapted such that electromagnetic radiation emitted from the re-radiating elements in response to electromagnetic radiation arriving from a predetermined direction interferes constructively at the location of the feed 207.

To this end, a model of the arrangement of the plurality of re-radiating elements 206 is provided. The model of arrangement defines a shape for each of the plurality of re-radiating elements and comprises a plurality of free parameters. The free parameters may quantify the shape of each of the plurality of re-radiating elements 206, as described above for some exemplary embodiments of the present invention.

At least one antenna gain is calculated for electromagnetic radiation in a predetermined frequency range for an antenna comprising a plurality of re-radiating elements arranged according to the model of arrangement, and for one or more parameter sets.

In embodiments of the present invention wherein the antenna 200 is adapted for use in a satellite receiver system, the predetermined frequency range may comprise one or more frequency bands used in satellite broadcasting. The specifications of the Direct-To-Home (DTH) service standard which is well known to persons skilled in the art require a bandwidth from 10.7 GHz to 12.75 GHz which includes the following frequency ranges:

FSS (Fixed Satellite Service): 10.7-11.7 GHz;

DBS (Direct Broadcasting Satellite): 11.7-12.5 GHz; and

SMS (Satellite Multi Service): 12.5-12.75 GHz.

Hence, an antenna adapted to receive signals in each of these frequency ranges, may have a bandwidth of about 17% or more. Moreover, broadcasting satellites can transmit signals having different polarization, in particular linear polarization in either of two polarization directions commonly denoted as “H” and “V”, and circular polarization in either of two polarization directions commonly denoted as “RHCP” and “LHCP”. In methods of manufacturing an antenna according to the present invention, a plurality of antenna gains may be calculated for electromagnetic radiation having frequencies in one or more of the FSS, DBS and SMS frequency ranges and for electromagnetic radiation having different polarization.

In one specific example of a method of manufacturing an antenna according to the present invention, a first antenna gain is calculated for electromagnetic radiation having a frequency of about 11.7 GHz, a second antenna gain is calculated for electromagnetic radiation having a frequency of about 10.7 GHz and a third antenna gain is calculated for electromagnetic radiation having a frequency of about 12.7 GHz.

As persons skilled in the art know, the antenna gain may be calculated as follows. The antenna gain is defined as G=ηD , where D is the antenna directivity, η=P_{rad}/Pᵢₙ the radiation efficiency, P_{rad} the power radiated by the antenna and Pᵢₙ the power supplied to the antenna. Gain reflects the fact that for real antennas some of the input power is lost on the antenna. Since reflect array antennas losses are very low, the gain value is approximately equal to the directivity value, i.e., G≈D . Hence, for this kind of antennas directivity can be profitably evaluated by

$$D = \frac{4 π}{{λ}^{2}} \frac{{\vert {\int }_{{S}_{a}} \int {{E}^{r}}_{a} ⅆ S \vert}^{2}}{{\int }_{{S}_{a}} \int \vert {{E}^{r}}_{a} \vert ⅆ S}$$

where [symbol] ₐ is the electric field on the equivalent aperture Sₐ and λ the wavelength. As persons skilled in the art know, the electric field [symbol] ₐ may be calculated by numerically solving Maxwell's equations or a known approximation thereof.

The at least one antenna gain is optimized with respect to the plurality of free parameters. In the optimization, a quantity which characterizes the one or more antenna gains is determined. If a single antenna gain is calculated for each parameter set, the quantity characterizing the antenna gain can be the antenna gain itself. In embodiments wherein a plurality of antenna gains is calculated for each parameter set, the quantity characterizing the plurality of antenna gains can comprise an average of the antenna gains, a sum of the antenna gains and/or a median of the antenna gains. In further embodiments, a weighted average of the antenna gains can be calculated, wherein frequencies and/or polarization directions which are of greater importance for receiving the signals of interest obtain greater weights than other, less important frequencies and/or polarization directions.

Then, a maximization of the quantity characterizing the one or more antenna gains with respect to the plurality of free parameters is performed. In some embodiments of the present invention, the maximization can be performed by means of an evolutionary optimization algorithm.

Evolutionary optimization uses concepts inspired by biological evolution such as reproduction, mutation, recombination and selection to find a solution to a computational problem. A population of candidate solutions is provided. Each of the candidate solutions may comprise a set of parameters for the model of arrangement. The quantity characterizing the one or more antenna gains defines a measure of the evolutionary fitness of each of the candidate solutions. Typically, greater antenna gains for electromagnetic radiation arriving from the predetermined direction correspond to a greater fitness of the candidate solutions. A reproduction of a candidate solution can be performed by copying the candidate solution. A mutation of a candidate solution can be performed by randomly varying one or more of the parameters. A recombination (which is the counterpart of biological reproduction) can be performed by creating a new parameter set which is combined from parameters selected from two “parent” candidate solutions. Selection can be performed by deleting candidate solutions which yield relatively low values of the quantity characterizing the one or more antenna gains.

At the beginning of the evolutionary optimization, the population of candidate solutions is provided by creating a plurality of parameter sets. The parameter sets can be created by providing parameter sets with which reasonable antenna gains have been obtained in similar cases. In one embodiment of the present invention, the candidate solutions comprise parameter values which have shown to yield reasonable antenna gains for similar values of the predetermined direction from which the electromagnetic radiation arrives and similar values of the feed location. In other embodiments, the initial candidate solutions may be provided with randomly chosen parameter values.

Then, steps of reproduction, mutation, recombination and selection are performed. In the course of time, candidate solutions which yield relatively low values of the quantity characterizing the one or more antenna gains are eliminated, whereas candidate solutions yielding relatively large values of the quantity characterizing the one or more antenna gain are favored and have a high likelihood of being reproduced. Mutations and recombination allow an exploration of the parameter space.

The algorithm can be stopped as soon as antenna gains which are sufficient for practical applications are obtained. In embodiments of the present invention wherein the antenna 200 is provided in a satellite broadcasting receiver system, antenna gains of about 35 dB over all the bandwidth may be sufficient for a reasonable quality of reception.

The present invention is not restricted to embodiments wherein the calculation of the arrangement of the plurality of re-radiating elements is performed by means of an evolutionary optimization algorithm. In other embodiments, other optimization algorithms known to persons skilled in the art can be used, for example simulated annealing and/or conjugate gradient descent.

After the calculation of the arrangement of the plurality of re-radiating elements 206, the plurality of re-radiating elements 206 is provided in at least one plane being parallel to the fixed surface, wherein the plurality of re-radiating elements 206 is arranged based on the calculated arrangement. The provision of the plurality of re-radiating elements 206 can comprise forming the plurality of re-radiating elements 206 on the surface 220 of the substrate 220.

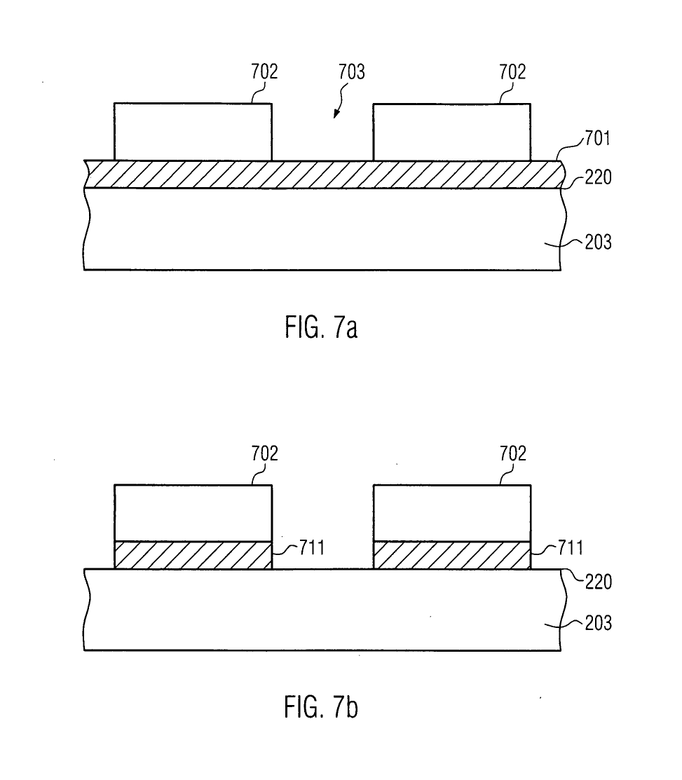

FIG. 7a shows a schematic cross-sectional view of the substrate 203 in a first stage of the formation of the plurality of re-radiating elements. A layer 701 of an electrically conductive material is provided on the surface 220 of the substrate 203. Thereafter, a layer 702 of a photoresist material is formed over the surface 220 of the substrate 203. In some embodiments of the present invention, the layer 701 of electrically conductive material and the photoresist layer 702 may cover substantially the entire surface 220 of the substrate 203. The layer 701 of electrically conductive material can be formed by means of methods known to persons skilled in the art such a deposition process and/or an etching process. The layer 702 of photoresist can be formed by means of known methods such as spin coating or spraying a solution of the photoresist on the layer 701 of electrically conductive material. In other embodiments, the substrate 203 may be provided in form of a blank circuit board on which the layer 701 of electrically conductive material and the layer 702 of photoresist are preformed.

Portions of the layer 702 of photoresist on which the re-radiating elements are to be formed are exposed. To this end, the portions of the layer of photoresist are irradiated with ultraviolet light. In some embodiments of the present invention, this can be done by covering the surface of the layer 702 of photoresist with a mask adapted to absorb ultraviolet light impinging on the portions which are to be exposed, which may be effected by printing a pattern corresponding to the arrangement of the re-radiating elements on the mask. In other embodiments of the present invention, the surface of the layer 702 of photoresist can be scanned with an ultraviolet laser, wherein the laser is modulated such that only portions of the photoresist layer 702 which are located at the locations where the plurality of re-radiating elements 206 is to be formed are irradiated.

FIG. 7b shows a schematic cross-sectional view of the substrate 203 in a later stage of the manufacturing process.

The photoresist is developed in order to remove the irradiated portions of the layer 702 of photoresist and the substrate 203. Thereby, openings 703 are formed on the layer 702 of photoresist. Then, the substrate 203 is exposed to an etchant adapted to remove portions of the layer 701 of electrically conductive material exposed at the bottom of the openings 703. As persons skilled in the art know, this can be done by inserting the substrate 203 in a bath of a developer solution and a bath of an etching solution, respectively. Finally, portions of the photoresist layer 702 which are still on the substrate 203 are removed by means of a known solvent.

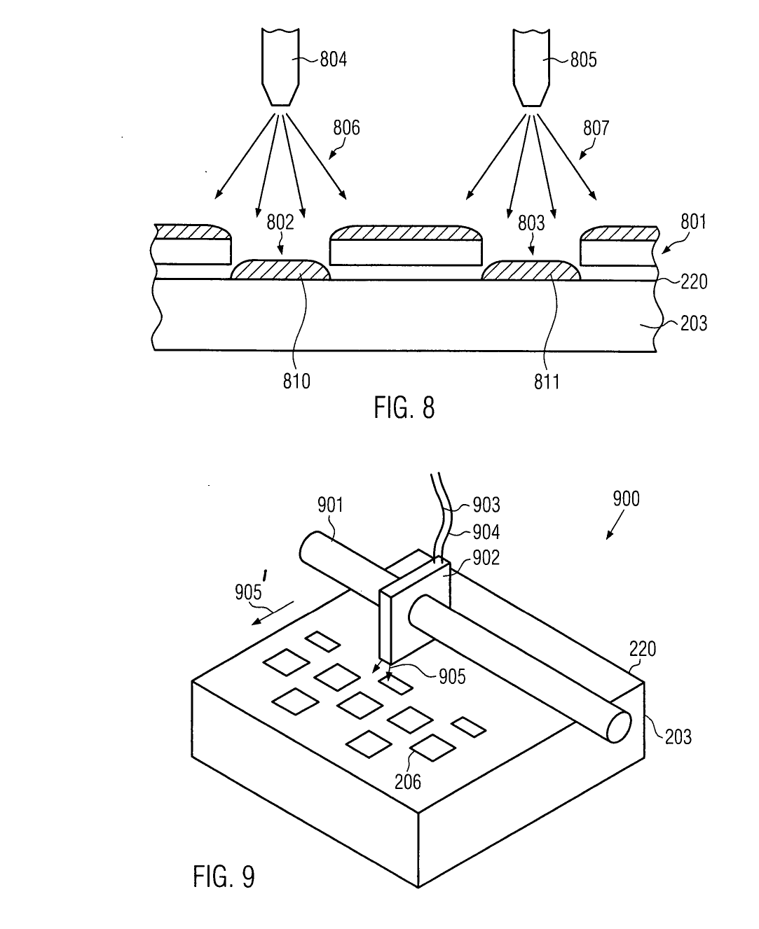

FIG. 8 shows a schematic cross-sectional view of the substrate 203 in a stage of a manufacturing process according to another embodiment of the present invention.

A stencil 801 having a plurality of openings 802, 803 arranged according to the arrangement of the plurality of re-radiating elements 206 is provided. The stencil 801 may be formed by means of known methods such as laser cutting or chemical etching. In laser cutting, a blank stencil is irradiated with a laser beam. The laser beam melts and/or evaporates portions of the blank stencil. Thus, openings can be cut into the blank stencil.

In chemical etching, a layer of photoresist is formed over a blank stencil. Portions of the photoresist corresponding to the locations where the openings are to be formed are exposed and etched away. Thereafter, the blank stencil is exposed to an etchant. The etchand etches portions of the blank stencil which are not covered by the photoresist, leaving portions of the blank stencil protected by the photoresist substantially intact. Thus, openings are formed.

The surface 220 of the substrate 203 is covered with the stencil 801. Thereafter, one or more sprays 806, 807 of a paint comprising an electrically conductive material are directed to the surface 220 of the substrate 203. To this end, one or more nozzles 804 adapted to create sprays of the paint can be directed towards the surface 220 of the substrate 203. In some embodiments of the present invention, the nozzles 804, 805 can be moved relative to the substrate 203. This can be done by means of a machine. In other embodiments, the one or more nozzles 804, 805 can be moved manually. In one particular embodiment of the present invention, a spray of a paint comprising an electrically conductive material can be provided by means of a spray can which may be operated manually.

Forming the plurality of re-radiating elements 206 by means of a spray of a paint comprising electrically conductive material is particularly advantageous in embodiments wherein the substrate 203 is provided in form of a stationary support member comprising the fixed surface 201. For example, in embodiments wherein the substrate 203 comprises a wall, roof or window of a building, the plurality of re-radiating elements 206 can be formed by attaching the stencil 801 to the substrate 203, and spraying paint comprising an electrically conductive material towards the substrate 203.

FIG. 9 shows a schematic perspective view of the substrate 203 in a stage of a manufacturing process according to yet another embodiment of the present invention. In this embodiment, a pattern corresponding to the arrangement of the plurality of re-radiating elements is printed on the surface 220 of the substrate 203. This can be done by means of a printer 900 comprising a paint dispenser 902 movable along a rod 901 and means for moving the substrate 203 in a direction transverse to the direction of the rod 901.

The paint dispenser 902 is moved relative to the surface 220 of the substrate 203. The paint dispenser 902 is adapted to supply paint 905 comprising an electrically conductive material to portions of the surface 220 of the substrate 203 on which the plurality of re-radiating elements 206 is to be formed. To this end, the paint dispenser 902 may comprise an ink-jet printer head adapted to propel doplets of the paint towards the surface 220 of the substrate 203 using means and methods known to persons skilled in the art of ink-jet printing. The paint dispenser 902 can be connected to lines 903, 904 adapted to supply electric power, signals adapted to control the operation of the paint dispenser 902 and/or paint to the paint dispenser 902.

The paint dispenser 902 may be moved in a first direction along the rod 901. Thus, the paint dispenser 902 can provide the paint comprising the electrically conductive material to a line on the surface 220 of the substrate 203 being substantially parallel to the rod 901. The substrate 203 can be moved in a second direction which is indicated by arrow 905′ in FIG. 9. For this purpose, the means for moving the substrate 203 can comprise one or more motors. In other embodiments, the substrate 203 may be maintained at a fixed location while the rod 901 is moved in the direction of arrow 901.

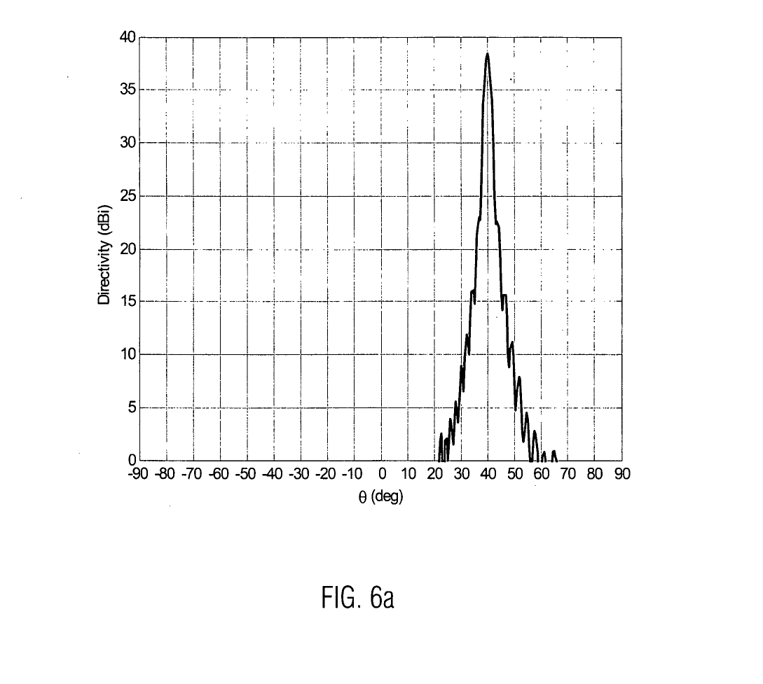

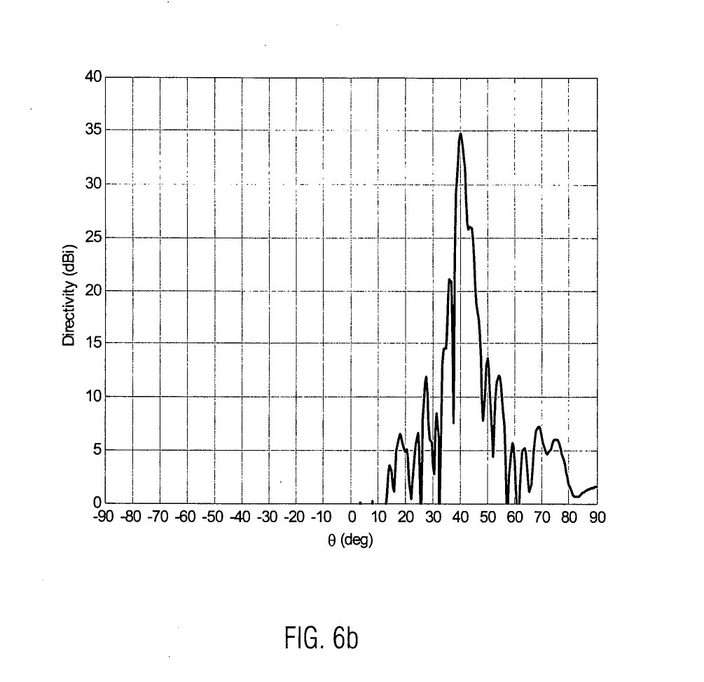

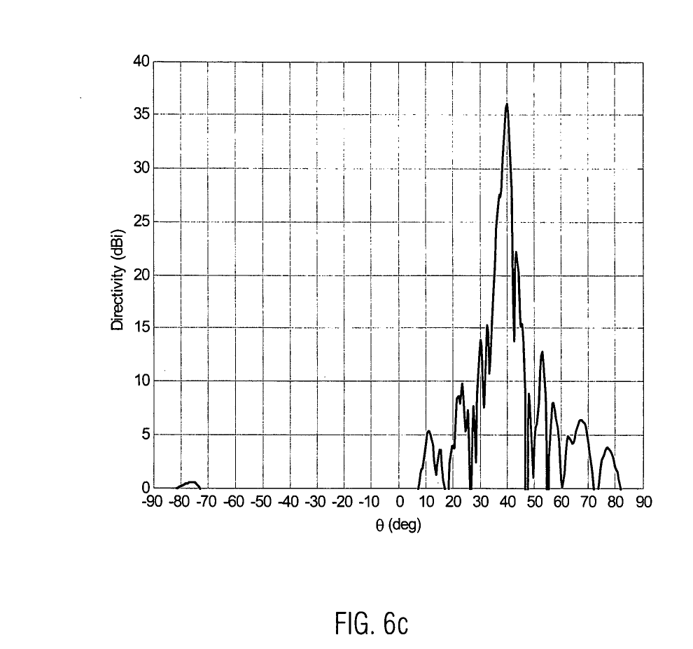

FIGS. 6a to 6c show plots of the directional dependence of antenna gains obtained by means of an antenna according to the present invention. On a substrate having an overall circular shape with a diameter of 87.5 cm and a thickness of 2-3 mm, 3657 re-radiating elements having the shape of a Maltese cross as described above with reference to FIG. 5e were formed. The arrangement of the re-radiating elements, in particular the dimensions of the individual re-radiating elements were determined by means of an evolutionary optimization algorithm as described above.

After the formation of the plurality of re-radiating elements 206 on the surface 220 of the substrate 203, the substrate 203, when being provided as a separate component, is mounted on the fixed surface 201. In some embodiments of the present invention, the substrate 203 can then be covered by paint and/or a plastering having a color and/or surface texture similar to that of the fixed surface 201. Thus, the substrate 203 may be camouflaged in order to not disturb the visual appearance of the fixed surface 201. Additionally, the feed 207 and the feed support 205 may be mounted on the fixed surface 201.

FIG. 6a shows the directional dependence of the antenna gain obtained for a frequency of 11.7 GHz. FIG. 6b shows the directional dependency of the antenna gain obtained for a frequency of 10.7 GH and FIG. 6c shows the directional dependence of the antenna gain obtained for a frequency of 12.7 GHz. For all frequencies, at an angle θ=40° which corresponds to the predetermined direction of arrival, an antenna gain of about 35 dBi is obtained. Consequently, the antenna 200 according to the present invention fulfills the requirements of an antenna to be used in a satellite receiver system.

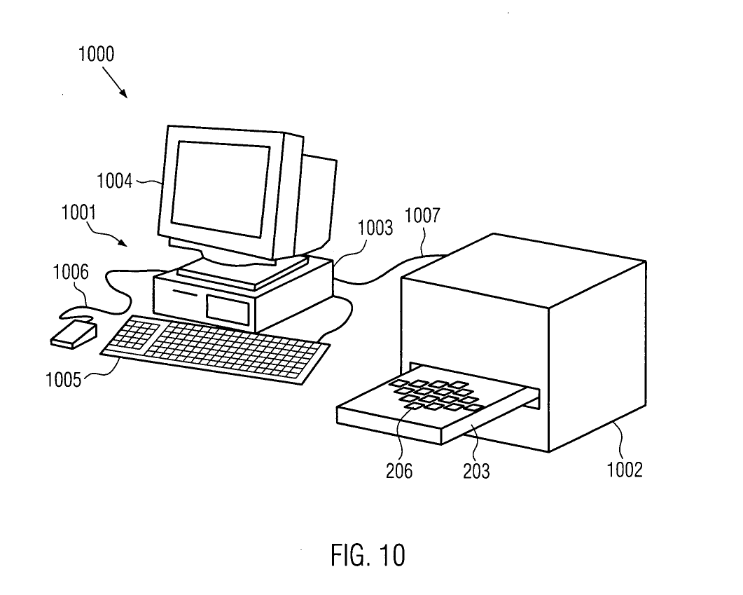

FIG. 10 shows a schematic perspective view of an apparatus 1000 for manufacturing an antenna according to an embodiment of the present invention.

The apparatus 1000 comprises a data processor 1001 configured to calculate an arrangement of the plurality of re-radiating elements 206 in at least one plane having an orientation corresponding to an orientation of the fixed surface 201, the arrangement being adapted such that electromagnetic radiation emitted from the re-radiating elements in response to electromagnetic radiation arriving from a predetermined direction interferes constructively at the location where the feed 207 is to be installed.

The data processor 1001 can be provided in form of a computer comprising a central processing unit 1003, a display 1004 and input means, for example a keyboard 1005 and/or a mouse 1006. The central processing unit 1003 can comprise a program configured to calculate the arrangement of the plurality of re-radiating elements 206 using the methods described above. Data which represent the orientation of the fixed surface 201, for example components of the normal vector 202 of the fixed surface 201 can be input by means of the keyboard 1005 and/or the mouse 1006.

The data processor 1001 is connected to means 1002 for forming the plurality of re-radiating elements 206 on the surface 220 of the substrate 203. A data transmission line 1007 which may comprise a network cable or a Universal Serial Bus (USB) connection can connect the data processor 1001 and the means 1002 for forming the plurality of re-radiating elements 206. In other embodiments, a wireless connection can be established between the data processor 1001 and the means 1002 for forming the plurality of re-radiating elements 206.

In some embodiments of the present invention, the means 1002 for forming the plurality of re-radiating elements 206 comprise means for forming a mask over a layer of electrically conductive material formed over the surface 220 of the substrate 203, means for removing portions of the layer of electrically conductive material which are not covered by the mask and means for removing the mask. Such means may be provided in form of printed circuit board manufacturing machinery of a type known to persons skilled in the art.

In other embodiments, the means 1002 for forming the plurality of re-radiating elements 206 comprise means for forming a stencil similar to the stencil 801 described above with reference to FIG. 8 having a plurality of openings arranged according to the arrangement of the plurality of re-radiating elements over the surface 220 of the substrate 203. In such embodiments, the means 1002 for forming the plurality of re-radiating elements 206 may comprise a laser cutter of a type known to persons skilled in the art. The means 1002 for forming the plurality of re-radiating elements 206 may further be adapted to spray a paint comprising an electrically conductive material towards the surface 203 covered with the stencil such as, for example, nozzles similar to the nozzles 804, 805 described above with reference to FIG. 8. In other embodiments, the means 1002 for forming the plurality of re-radiating elements 206 are only adapted for the formation of a stencil. The stencil may then manually be attached to the substrate 201 and the paint comprising the electrically conductive material may manually be sprayed towards the surface 220 of the substrate 203, for example by means of a spray can. Such embodiments may advantageously be employed in embodiments wherein the surface 220 of the substrate 203 is identical to the fixed surface 201, for example in embodiments wherein the substrate 203 comprises a part of a building such as a wall, a roof and/or a window.

In still further embodiments of the present invention, the means 1002 for forming the plurality of re-radiating elements may comprise a printer adapted to print a pattern corresponding to the arrangement of the plurality of re-radiating elements on the surface 220 of the substrate 203. The printer may have a configuration similar to that of the printer 900 described above with reference to FIG. 9.

While the preferred embodiments have been illustrated and described, it will be obvious to those skilled in the art that various modifications may be made without departing from the spirit and scope of this invention.

What is claimed is:

1. An antenna, comprising:
a plurality of re-radiating elements arranged in at least one plane being parallel to a fixed surface, said arrangement being adapted such that electromagnetic radiation emitted from said plurality of re-radiating elements in response to electromagnetic radiation arriving from a predetermined direction interferes constructively at a feed location; and
a feed provided at the feed location.

2. An antenna according to claim 1, wherein:
the fixed surface comprises a part of a building.

3. An antenna according to claim 2, wherein:
the fixed surface comprises a part of at least one of a wall, a roof and a window of said building.

4. An antenna according to claim 2, wherein:
said plurality of re-radiating elements is provided under at least one of a plastering and paint of said building.

5. An antenna according to claim 1, wherein:
each of said plurality of re-radiating elements comprises at least one layer of an electrically conductive material formed on at least one surface of a substrate.

6. An antenna according to claim 5, wherein:
the at least one surface of the substrate comprises the fixed surface.

7. An Antenna according to claim 5, wherein:
at least one of said plurality of re-radiating elements is selected from the group consisting of a shape comprising one of a plurality of coplanar concentric annular rings, a plurality of stacked concentric annular rings, a plurality of stacked rectangular patches, a patch having a plurality of coplanar symmetrical stubs, a Maltese cross, an annular patch comprising one or more slot systems, a plurality of stacked strip patches, a rectangular patch, a cross-shaped opening and a curl-shaped element, and a plurality of stacked patches electromagnetically coupled by slot systems.

8. An antenna according to claim 5, wherein:
at least one of said plurality of re-radiating elements has a shape comprising a rectangular patch comprising slots extending from vertices of said patch towards a center of said patch.

9. An antenna according to claim 8, wherein:
at least one of the slots comprises a pair of edges being parallel to a diagonal of the rectangular patch.

10. An antenna according to claim 8, further comprising:
at least one switching element adapted to open and/or close an electrical connection between opposite sides of at least one of the slots.

11. An antenna according to claim 10, wherein:
said at least one switching element comprises a micro-electro-mechanical system switch.

12. A satellite receiver system comprising:
a plurality of re-radiating elements arranged in at least one plane being parallel to a fixed surface, said arrangement being adapted such that electromagnetic radiation emitted from said plurality of re-radiating elements in response to electromagnetic radiation arriving from a predetermined direction interferes constructively at a feed location; and
a feed provided at the feed location.

13. A method of manufacturing an antenna, comprising the steps of:
determining an orientation of a fixed surface;
calculating an arrangement of a plurality of re-radiating elements in at least one plane having the orientation, the arrangement being adapted such that electromagnetic radiation emitted from the re-radiating elements in response to electromagnetic radiation arriving from a predetermined direction interferes constructively at a predetermined feed location;
providing a plurality of re-radiating elements in the at least one plane, the plurality of re-radiating elements being arranged based on the calculated arrangement; and
providing a feed at the predetermined feed location.

14. A method of manufacturing an antenna according to claim 13, wherein:
the fixed surface comprises a part of a building.

15. A method of manufacturing an antenna according to claim 14, wherein:
the fixed surface comprises a part of at least one of a roof, a wall and a window of the building.

16. A method of manufacturing an antenna according to claim 14, wherein:
the plurality of re-radiating elements is provided under at least one of a plastering and paint of said building.

17. A method of manufacturing an antenna according to claim 13, wherein:
the antenna is provided as a component of a satellite receiver system.

18. A method of manufacturing an antenna according to claims 13, wherein:
said calculation of said arrangement of the plurality of re-radiating elements comprises,
providing a model of arrangement having a plurality of free parameters;
calculating at least one antenna gain for electromagnetic radiation in a predetermined frequency range for an antenna comprising a plurality of re-radiating elements arranged according to the model of arrangement; and
optimizing the at least one antenna gain with respect to the plurality of free parameters.

19. A method of manufacturing an antenna according to claim 18, wherein:
said calculation of the at least one antenna gain comprises calculating a plurality of antenna gains in the predetermined frequency range, the predetermined frequency range having a bandwidth of 17% or more, and the electromagnetic radiation comprising signals of different polarization.

20. A method of manufacturing an antenna according to claim 18, wherein:
the model of arrangement defines for each of the plurality of re-radiating elements is selected from the group consisting of a shape comprising one of a plurality of coplanar concentric annular rings, a plurality of stacked concentric annular rings, a plurality of stacked rectangular patches, a patch having a plurality of coplanar symmetrical stubs, a Maltese cross, an annular patch comprising one or more slot systems a plurality of stacked strip patches, a rectangular patch, a cross-shaped opening and a curl-shaped element, and a plurality of stacked patches electromagnetically coupled by slot systems.

21. A method of manufacturing an antenna according to claim 18, wherein:
the model of arrangement defines for each of the plurality of re-radiating elements a shape comprising a rectangular patch comprising slots extending from vertices of said patch towards a center of said patch.

22. A method of manufacturing an antenna according to claim 21, wherein:
each of the slots comprises a pair of edges being parallel to a diagonal of the rectangular patch.

23. A method of manufacturing an antenna according to claim 21, further comprising the step of:
providing at least one switching element adapted to open and/or close an electrical connection between opposite sides of at least one of the slots.

24. A method of manufacturing an antenna according to claim 23, wherein:
the at least one switching element comprises a micro-electrical-mechanical system switch.

25. A method of manufacturing an antenna according to claim 18, wherein:
said step of optimizing comprises performing an evolutionary optimization algorithm.

26. A method of manufacturing an antenna according to claim 13, wherein:
said step of providing the plurality of re-radiating elements comprises depositing an electrically conductive material on at least one surface of a substrate.

27. A method of manufacturing an antenna according to claim 26, wherein:
the at least one surface of the substrate comprises the fixed surface.

28. A method of manufacturing an antenna according to claim 26, wherein:
the deposition of the electrically conductive material comprises the steps of,
forming a mask over a layer of electrically conductive material formed over the at least one surface of the substrate;
removing portions of the layer of electrically conductive material which are not covered by the mask; and
removing the mask.

29. A method of manufacturing an antenna according to claim 26, wherein:
the deposition of said electrically conductive material comprises spraying paint comprising the electrically conductive material to the at least one surface of the substrate.

30. A method of manufacturing an antenna according to claim 29, further comprising the step of:
providing a stencil having a plurality of openings arranged according to the model of arrangement of the plurality of re-radiating elements over the at least one surface of the substrate.

31. A method of manufacturing an antenna according to claim 26, wherein:
the deposition of the electrically conductive material comprises printing a pattern corresponding to the model of arrangement of the plurality of re-radiating elements on the at least one surface of the substrate using paint comprising the electrically conductive material.

32. An apparatus for manufacturing an antenna comprising:
a data processor configured to calculate an arrangement of a plurality of re-radiating elements in at least one plane having an orientation corresponding to an orientation of a fixed surface, the arrangement being adapted such that electromagnetic radiation emitted from the plurality of re-radiating elements in response to electromagnetic radiation arriving from a predetermined direction interferes constructively at a predetermined feed location; and
means for forming the plurality of re-radiating elements on at least one surface of a substrate, the plurality of re-radiating elements being arranged based on the calculated arrangement.

33. An apparatus for manufacturing an antenna according to claim 32, wherein:
said data processor is configured to provide a model of arrangement having a plurality of free parameters, to calculate at least one antenna gain for electromagnetic radiation in a predetermined frequency range for an antenna comprising a plurality of re-radiating elements arranged according to the model of arrangement and to optimize the at least one antenna gain with respect to the plurality of free parameters.

34. An apparatus for manufacturing an antenna according to claim 32, wherein:
the at least one antenna gain comprises a plurality of antenna gains for a plurality of frequencies in the predetermined frequency range, the predetermined frequency range having a bandwidth of at least 17%, the electromagnetic radiation comprising signals with different polarizations.

35. An apparatus for manufacturing an antenna according to claim 33, wherein:
the model of arrangement defines for each of said plurality of re-radiating elements is selected from the group consisting of a shape comprising one of a plurality of coplanar concentric annular rings, a plurality of stacked concentric annular rings, a plurality of stacked rectangular patches, a patch having a plurality of coplanar symmetrical stubs, a Maltese cross, an annular patch comprising one or more slot systems, a plurality of stacked strip patches, a rectangular patch, a cross-shaped opening and a curl-shaped element, and a plurality of stacked patches electromagnetically coupled by slot systems.

36. An apparatus for manufacturing an antenna according to claim 33, wherein:
the model of arrangement defines for each of said plurality of re-radiating elements a shape comprising a rectangular patch comprising slots extending from vertices of the patch towards a center of the patch.

37. An apparatus for manufacturing an antenna according to claim 36, wherein:
each of the slots comprises a pair of edges being parallel to a diagonal of the rectangular patch.

38. An apparatus for manufacturing an antenna according to claim 36, further comprising:
means for providing at least one switching element adapted to open or close an electrical connection between opposite sides of at least one of the slots.

39. An apparatus for manufacturing an antenna according to claim 38, wherein:
the at least one switching element comprises a micro-electrical-mechanical system switch.

40. An apparatus for manufacturing an antenna according to claim 32, wherein:
said data processor is configured to perform an evolutionary optimization.

41. An apparatus for manufacturing an antenna according to claim 32, wherein:
said means for forming the plurality of re-radiating elements on at least one surface of the substrate comprise,
means for forming a mask over a layer of electrically conductive material formed over the at least one surface of the substrate;
means for removing portions of the layer of electrically conductive material which are not covered by the mask; and
means for removing the mask.

42. An apparatus for manufacturing an antenna according to claim 32, wherein:
said means for forming the plurality of re-radiating elements on at least one surface of the substrate comprise means for forming a stencil having a plurality of openings arranged according to the arrangement of the plurality of re-radiating elements over the at least one surface of the substrate.

43. An apparatus for manufacturing an antenna according to claim 32, wherein:
said means for forming the plurality of re-radiating elements on at least one surface of the substrate comprise a printer adapted to print a pattern corresponding to the arrangement of the plurality of re-radiating elements on the at least one surface of the substrate using paint comprising an electrically conductive material.
